(19) United States
(12) Patent Application Publication
(10) Pub. No.: US 2006/0279860 A1
(43) Pub. Date: Dec. 14, 2006

(54) Trailer Guide

(76) Inventor: Anthony E. Doiron, Santa Rosa, CA (US)

Correspondence Address: Michael L. Leetzow, Esq.;Michael L. Leetzow, P.A., 5213 SHORELINE CIRCLE, SANFORD, FL, 32771, US

(21) Appl. No.: 11/423,131

(22) Filed: Jun. 8, 2006

Related U.S. Application Data
(60) Provisional application No. 60/689,043, filed on Jun. 10, 2005.

(51) Int. Cl. G02B 5/08; G02B 7/18

(52) U.S. Cl. 359/841

(57) ABSTRACT

A trailer guide has an extendable arm member, a mounting element in which the extendable arm member is rotatably connected, a light element, and a biasing member. The trailer guide automatically returns to a stowed position after use when the trailer to which the trailer guide is mounted is moving forward at a predetermined speed.

### BACKGROUND OF THE INVENTION

1. Field of the Invention

The present invention relates generally to a trailer guide used to assist a driver in visualizing the location of a trailer attached to the driver's vehicle during backing maneuvers, and more particularly to a trailer guide that swings out away from the trailer and then automatically swings back toward the trailer.

2. Technical Background

There are a number of trailer lights and markers that are available to assist with visualization of the trailers during backing maneuvers. However, each of these are typically permanently installed in one particular configuration on the trailer, or are not always visible to the driver of the vehicle towing the trailer. This is especially true if the trailer or the cargo in the trailer is tall or large.

Other trailer markers or lights that can be seen by the vehicle's driver must be correctly positioned prior to moving the trailer, typically in a backwards direction, and then repositioned after loading, moving, or backing the trailer and before moving the trailer forward again. Positioning these trailer markers or lights requires that the driver and/or passengers get out of the vehicle, position the trailer markers or lights, get back into the vehicle, move the vehicle and trailer, and then get out of the vehicle to return the trailer markers or lights to the original or stowed position. Such trailer markers or lights are not convenient and may expose the driver and/or passenger to the weather or dangers while positioning and repositioning the trailer lights.

Therefore, a trailer guide that is easier to use, is lighted, and will automatically return to its original or stowed position is needed.

### SUMMARY OF THE INVENTION

To achieve these and other advantages and in accordance with the purpose of the invention as embodied and broadly described herein, the invention is directed in one aspect to a trailer guide to assist a driver in visualizing the location of a trailer that includes an extendable arm member, a mounting element for mounting the extendable arm member to a trailer, the extendable arm member being rotatably mounted to the mounting element to allow the extendable arm member to rotate relative to the mounting element, a light element disposed at one end of the extendable arm member, and a biasing element to bias the extendable arm member toward a first position relative to the mounting element,

In another aspect, disclosed herein is a trailer guide that includes an arm member, a mounting element for mounting the arm member to a trailer, the arm member being rotatably mounted to the mounting element to allow the arm member to rotate relative to the mounting element between a first position and a second position, and a light element disposed at one end of the arm member such that the light element can be seen from a front portion of the trailer guide when the arm is rotated to the first position.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a top view of one embodiment of a trailer guide according to the present invention with the arm member extended outward;

FIG. 2 is a perspective view from the rear of an alternative embodiment of the trailer guide of FIG. 1 attached to a portion of a trailer with the arm member extended outward away from the trailer according to the present invention;

FIG. 3 is a top view of another embodiment of a trailer guide according to the present invention with the arm member extended outward;

FIG. 4 is top view of the trailer guide of FIG. 3 with the arm member stowed in a traveling position;

FIG. 5 is a top view of another embodiment of a trailer guide according to the present invention with the arm ember extended outward;

FIG. 6 is a top view of the trailer guide of FIG. 5 with the arm member stowed in a traveling position;

FIG. 7 is a top, partial cross sectional view of another embodiment of a trailer guide according to the present invention with the arm member extended outward and attached to a trailer; and

FIG. 8 is a top, partial cross sectional view of the trailer guide of FIG. 7 with the arm member stowed in a traveling position.

### DETAILED DESCRIPTION OF THE PREFERRED EMBODIMENTS

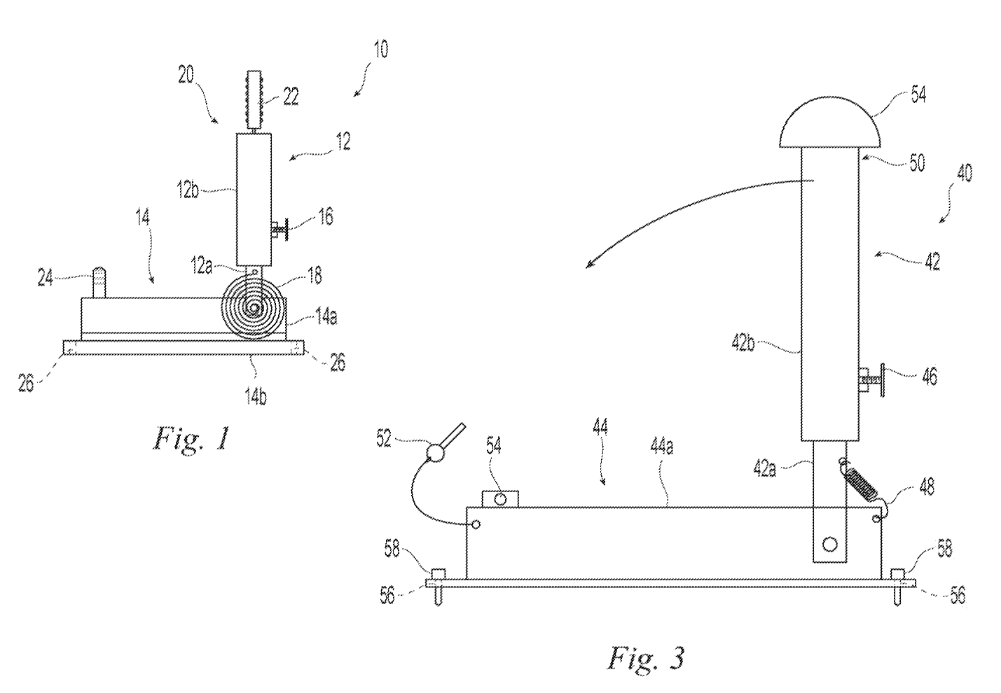

Reference will now be made in detail to the present preferred embodiment(s) of the invention, examples of which are illustrated in the accompanying drawings. Whenever possible, the same reference numerals will be used throughout the drawings to refer to the same or like parts. One embodiment of the present invention is shown in FIG. 1 and is designed generally throughout by the reference numeral 10.

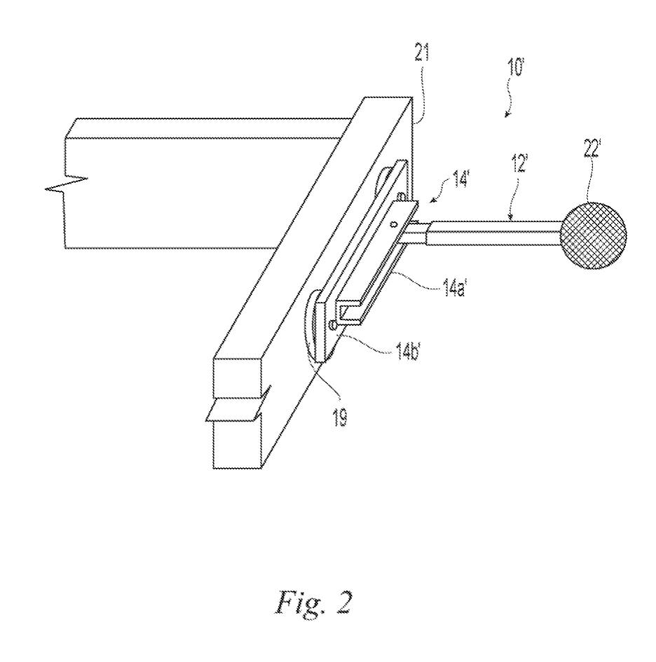

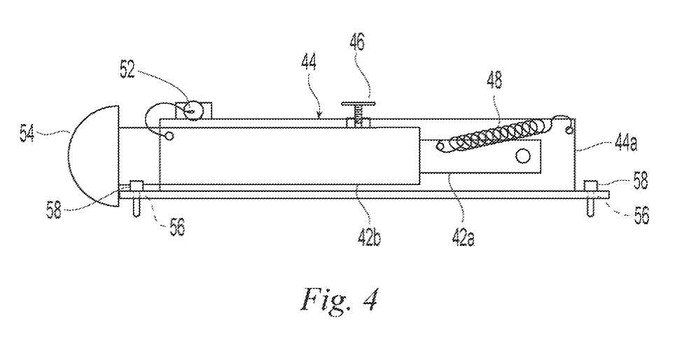

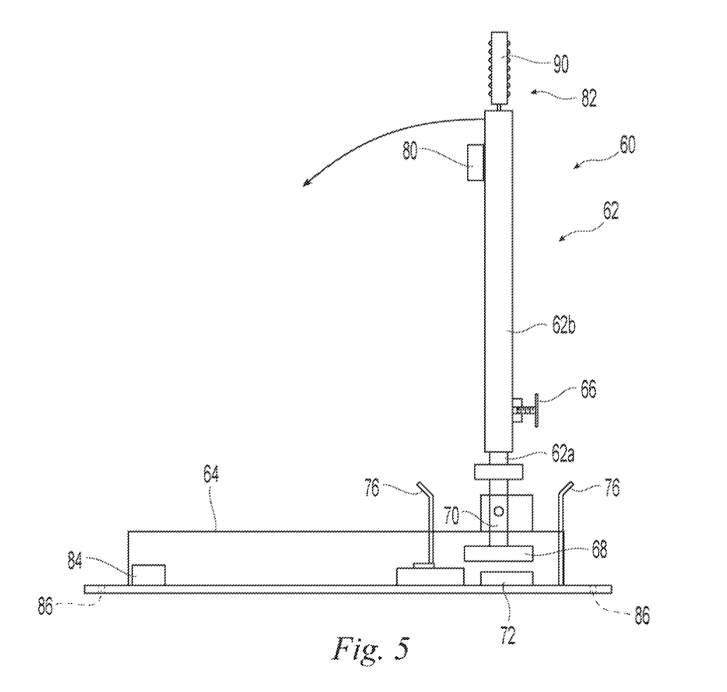

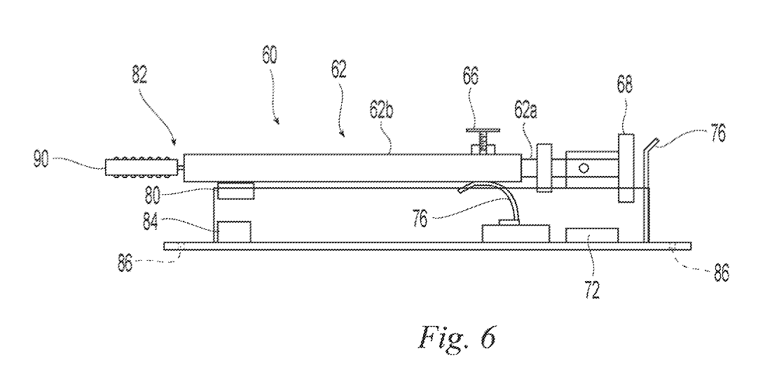

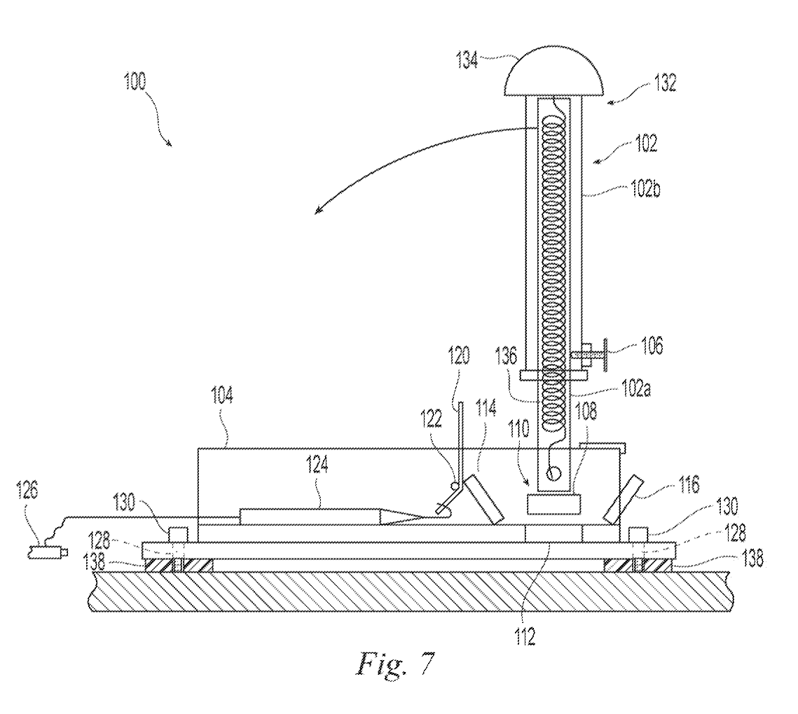

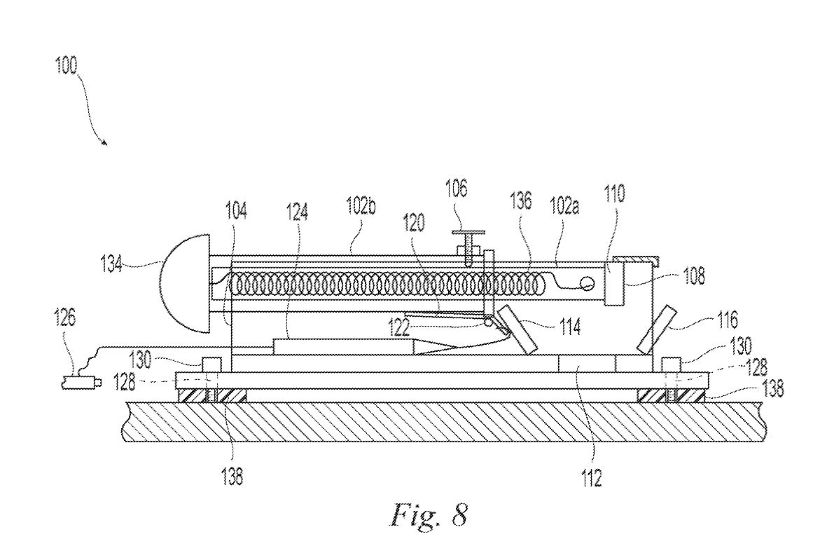

FIG. 2 schematically illustrates an alternative of the trailer guide of FIG. 1 attached to a portion of a trailer. FIGS. 3-4 schematically illustrate another embodiment of a trailer guide. FIGS. 5-6 illustrate another embodiment of a trailer guide according to the present invention. FIGS. 7-8 illustrate yet another alternative embodiment of a trailer guide according to the present invention.

FIG. 1 illustrates a trailer guide 10 according to one embodiment of the present invention. The trailer guide 10 includes an extendable arm member 12, the extendable arm member 12 has a first portion 12a and a second portion 12b. The first portion 12a of the extendable arm member 12 is preferably rotatably connected to mounting element 14. The first portion 12a also slidingly engages the second portion 12b and can be secured to second portion 12b, preferably with a screw 16. The first portion 12a preferably slides within the second portion 12b, although the second portion 12b could slide within the first portion 12a. It should also be noted that while a screw 16 is illustrated to maintain the position of the first portion 12a relative to the second portion 12b, alternative methods could be used (e.g., friction fit, gasket, etc.) instead of or in addition to the screw 16. The extendable arm member 12 may also be made of several portions and telescope to extend outwardly and still be within the scope of the present invention.

The extendable arm member 12 also has associated with it a biasing element 18, which is illustrated as a coil spring in FIG. 1. The coil spring 18 is attached to the extendable arm 12 and the mounting element 14 so as to bias the end 20 of the extendable arm 12 away from the mounting element 14. The biasing element 18 may be of any strength, but is preferable that the biasing element 18 maintains the extendable arm member 12 in the extended position illustrated in FIG. 1 during use (i.e., approximately about 90° relative to the mounting element 14). However, the biasing element 18 also preferably allows the extendable arm member 12 to be pushed back into the mounting element 14 as the vehicle and trailer are traveling at a certain speed, e.g., 10 miles per hour. In this way, the driver and/or passengers do not have to get out of the vehicle to return the extendable arm member 12 to the mounting element 14 and the stowed position.

At the end 20 of the extendable arm 12 is a light element 22 that is preferably visible at all times of the day and night. The light element 22 in the present embodiment of trailer guide 10 is preferably a reflector or a reflective surface. As illustrated, the reflector 22 is preferably oriented so as to be seen from both the front and the rear of the trailer guide 10. While the reflector 22 is illustrated as being two sided and relatively thin, it may be of any shape or configuration and be within the scope of the present invention. As such, it is easily visible at all times of the day—reflecting the sun during daytime and reflecting lights in the area at night. However, as discussed below in detail, the light element 22 may also be a light or LED, which is powered from the vehicle or by batteries that could be associated with the trailer guide 10.

The mounting element 14 is preferably made from clear plastic (as illustrated in all of the figures, except FIG. 2, to allow the components of the trailer guide to be easily viewed), but could be made of any appropriate materials, including, for example, sheet metal, aluminum, and steel. The mounting element 14 is illustrated in FIG. 1 as having a U-shaped protective member 14a and a base member 14b, but mounting element 14 may be one single element and need not have the protective member 14a. The extendable arm member 12 is preferably mounted between the arm portions of the U-shaped protective member 14a. Protective member 14a is provided preferably to provide protection to the extendable arm member 12 and provide structure for the biasing member 18 and to allow the extendable arm member 12 to be rotatably connected thereto. However, each of these functions may also be provided by only a base member 14b. Similarly, the base member 14b preferably provides strength to the trailer guide 10 and has the openings 26 for attachment to the trailer or other structure as noted in detail below, which may also be provided by the protective member 14a. The protective member 14a may also be L-shaped or have any other appropriate shape or configuration to provide protection to the extendable arm member 12.

The mounting element 14 also preferably has a retainer clip 24 to maintain the extendable arm 12 parallel to and at least partially within the mounting element 14 when it is not in use. In this stowed position, the end 20 of the extendable arm member 12 is adjacent to the mounting element 14. When the trailer guide 10 is to be used, the extendable arm member is released from the retainer clip 24, and the extendable arm member 12 is biased by biasing element 18 to a position that is about 90° from the mounting element 14 as illustrated in FIG. 1. While a retainer clip 24 is illustrated in FIG. 1, any appropriate method may be used to retain the extendable arm member 12 in the stowed position.

The mounting element 14 preferably has openings 26 that allow the trailer guide 10 to be attached directly to the trailer or, as described in detail below in reference to FIGS. 2 and 7, attached to removable attachment elements (such as magnets or hook-and-loop elements) so that the trailer guide 10 may be removed and stored in the vehicle or elsewhere.

Another trailer guide 10′ is illustrated in FIG. 2. The trailer guide 10′ is a schematic view of a trailer guide according to the present invention, and is illustrated as a representation of a trailer guide according to the present invention and how it attaches to a trailer. As with trailer guide 10, trailer guide 10′ has a extendable arm member 12′ with a light element 22′ at a distal end. The extendable arm member 12′ is rotatably attached to a mounting element 14′, which in turn are mounted to removable attachment elements 19. The removable attachment elements 19 are preferably magnetic to attach the trailer guide 10′ to a portion of the trailer 21. As illustrated in FIG. 2, the mounting element 14′ also has a U-shaped protective member 14a′ and a base member 14b′. As with the prior embodiment, the mounting element 14′ may be only the protective member 14a′ or base member 14b′. It is also noted that the protective member 14a′ need not be U-shaped.

Another embodiment of a trailer guide 40 according to the present invention is illustrated in FIGS. 3-4. The trailer guide 40 includes an extendable arm member 42, the extendable arm member 42 has a first portion 42a and a second portion 42b. The first portion 42a of the arm member is preferably rotatably connected to mounting element 44. The first portion 42a slidingly engages the second portion 42b and can be secured to second portion 42b, preferably with a screw 46. The first portion 42a preferably slides within the second portion 42b, although the second portion 42b could slide within the first portion 42a. It should also be noted that while a screw 46 is illustrated to maintain the position of the first portion 42a relative to the second portion 42b, alternative methods could be used (e.g., friction fit, gasket, etc.) instead of or in addition to the screw 46.

The extendable arm member 42 also has associated with it a biasing element 48, which is illustrated as a spring. The spring 48 has one end attached to the extendable arm 42 and the other end attached to mounting element 44 so as to bias the end 50 of the extendable arm 42 away from the mounting element 44. The spring 48 also preferably allows the extendible arm 42 to be pushed back toward mounting element 44 by wind resistance when the trailer to which the trailer guide 40 is attached reaches a predetermined speed.

The mounting element 44 also preferably has a pin 52 and at least one associated opening 54 on the mounting element 44 through which the pin 52 can be inserted to hold the extendable arm member 42 within the mounting element 44 when it is not in use. The mounting element 44 also preferably has openings 56 through which fasteners 58 may be inserted to mount the trailer guide 40 to a trailer (not shown), or, as described below, to removable attachment members, such as magnets. The fasteners 58 may be provided with the trailer guide 40 or be attached to the trailer and inserted from the back side of the mounting element 44 if preferred. It is also within the scope of the present invention that the fasteners 58 which are preferably bolts or screws, may be any appropriate type of fasteners, including rivets. The fasteners 58 may also connect the trailer guide 40 to removable attachment elements (such as magnets or hook-and-loop elements) as noted above.

The mounting element 44 is illustrated as being one piece, but may also be made of two separate but connected pieces as described above. Additionally, the support member 44 also has a U-shaped portion 44a to receive and protect the extendable arm 42 when in the stowed position of FIG. 4. The mounting element 44 may be made of any appropriate materials including, for example, plastic, sheet metal, aluminum, steel.

At the end 50 of the extendable arm 42 is a light element 54 that is preferably visible at all times of the day and night. The light element 54 in the present embodiment of trailer guide 40 is preferably a reflector. As illustrated, the reflector 54 is illustrated as being generally spherical in configuration (one half a sphere), but may be of any shape or configuration. Again, the light element 54 may also be a light or LED, which is powered from the vehicle or by batteries that could be associated with the trailer guide 40.

Another embodiment of a trailer guide 60 according to the present invention is illustrated in FIGS. 5-6. The trailer guide 60 includes an extendable arm member 62, the extendable arm member 62 has a first portion 62a and a second portion 62b. The first portion 62a of the arm member is preferably rotatably connected to mounting element 64. The mounting element 64, as with the prior embodiments, preferably includes a U-shaped protective portion to house and protect the extendable arm member 62. The first portion 62a of extendable arm member 62 slidingly engages the second portion 62b and can be secured to second portion 62b, preferably with a screw 66. The first portion 62a preferably slides within the second portion 62b, although the second portion 62b could slide within the first portion 62a. It should also be noted that while a screw 66 is illustrated to maintain the position of the first portion 62a relative to the second portion 62b, alternative methods could be used (e.g., friction fit, gasket, etc.) instead of or in addition to the screw 66.

The extendable arm member 62 also has associated with it a biasing element 68. The biasing element 68 is preferably a magnet that is attached to one end 70 of the first portion 62a adjacent the mounting element 64. The mounting element 64 also has a magnet 72 attached thereto, which is arranged so as to attract the magnet 68 attached to the end 70 of extendable arm member 62 when the two magnets 68,72 are close to one another. The magnetic attraction between the two magnets maintains the extendable arm member 62 outward so as to be visible from the vehicle.

Additionally, mounting element 64 preferably has two elastic members 74,76, illustrated as leaf springs, placed on either side of the extendable 62. The first elastic member 74 is used to bias the extendable arm member 62 outwardly so that the two magnets 68,72 can attract one another. Second elastic member 76, mounted toward the front end of the trailer guide 60, is similarly used to prevent the extendable arm member 62 from rotating too far forward and allows the magnets 68,72 to magnetically engage one another.

The extendable arm member 62 preferably has a retaining magnet 80 mounted near its end 82. The retaining magnet 80 corresponds to and magnetically engages the magnet 84 mounted on the mounting element 64. The magnets 80,84 work together to magnetically hold the extendable arm member 62 within the mounting element 64 when it is not in use. See FIG. 6. The mounting element 64 also preferably has openings 86 through which fasteners may be inserted to mount the trailer guide 60 to a trailer (not shown). The fasteners 78 may be provided with the trailer guide 60 or be attached to the trailer and inserted from the back side of the mounting element if preferred. It is also within the scope of the present invention that the fasteners 78, which are preferably bolts or screws, but may be any appropriate type of fastener, including rivets. The fasteners 78 may also connect the trailer guide 60 removable attachment elements (such as magnets or hook-and-loop elements) as described above.

At the end 82 of the extendable arm 62 is a light element 90 that is preferably visible at all times of the day and night. The light element 90 in the present embodiment of trailer guide 60 is preferably a two-sided reflector, but may be of any shape or configuration. Again, the light element 90 may also be a light or LED, which is powered from the vehicle or by batteries that could be associated with the trailer guide 60.

Another embodiment of a trailer guide 100 according to the present invention is illustrated in FIGS. 7-8. The trailer guide 100 includes an extendable arm member 102, the extendable arm member 102 has a first portion 102a and a second portion 102b. The first portion 102a of the arm member is preferably rotatably connected to mounting element 104. The first portion 102a slidingly engages the second portion 102b and can be secured to second portion 102b, preferably with a screw 106. The first portion 102a preferably slides within the second portion 102b, although the second portion 102b could slide within the first portion 102a. It should also be noted that while a screw 106 is illustrated to maintain the position of the first portion 102a relative to the second portion 102b, alternative methods could be used (e.g., friction fit, gasket, etc.) instead of or in addition to the screw 106.

The extendable arm member 102 also has associated with it a biasing element 108. The biasing element 108 is a magnet that is attached to one end 110 of the first portion 102a adjacent the mounting element 104. The mounting element 104 also has a magnet 112 attached thereto, which is arranged so as to attract the magnet 108 attached to the end 110 of extendable arm member 102 when the two magnets 108,112 are close to one another. The magnetic attraction between the two magnets 108,112 maintains the extendable arm member 102 in an outward position. See FIG. 7.

Additionally, mounting element 104 preferably has two additional magnetic elements 114,116 placed on either side of the extendable arm member 102. The additional magnetic elements 114,116 are arranged so as to repel the magnet 108, thereby centering the magnet 108 (and also extendable arm member 102) over the magnet 112 and maintaining the extendable arm member 102 outwardly. The magnetic element 116 is also positioned so that when the extendable arm member 102 is parallel to and against the mounting element 104 (from being manually positioned there or from the wind forcing the extendable arm member 102 backwards), the magnetic element 116 pushes the magnet 108 outward against the portion 118 of the mounting element 104 to maintain the extendable arm member 102 against the mounting element 104. See FIG. 8.

The mounting element 104 preferably has a lever 120 that rotates about point 122 and is connected to actuator 124. Actuator 124 is in turn attached to switch 126, which is preferably mounted in the vehicle within reach of the driver. When the extendable arm member 102 is in the stowed position (against the mounting element 104) and the lever is activated by switch 126, the lever 120 rotates the extendable arm member 102 out to its extended position shown in FIG. 7. The magnets 108,114,116 maintain the extendable arm member 102 in the extended position as described above.

The mounting element 104 also preferably has openings 128 through which fasteners 130 may be inserted to mount the trailer guide 100 to a trailer (not shown). The fasteners 130 may be provided with the trailer guide 100 or be attached to the trailer and inserted from the back side of the mounting element if preferred. It is also within the scope of the present invention that the fasteners 130, which are preferably bolts or screws, but may be any appropriate type of fastener, including rivets. The fasteners 130 may also connect the trailer guide 100 to removable attachment elements (such as magnets or hook-and-loop elements). The trailer guide 100 may also be secured to the trailer in a number of other ways. For example, a z-bar may be attached to the trailer and the trailer guides (10,10′,40,60,100) may be cradled between the z-bar and the trailer.

At the end 132 of the extendable arm 102 is a light element 134 that is preferably visible at all times of the day and night. The light element 134 in the present embodiment of trailer (guide 100 is preferably a light or LED, but may also be a two-sided reflector of any shape or configuration. The light element 134 is powered with the electrical wires 136 that preferably extend inside and through the extendable arm member 102. The electrical wires 136 are in electrical communication with a power source either in the vehicle, on the trailer, or by batteries that could be associated with the trailer guide 100. The electrical wires 136 are also preferably extendable with the extendable arm member 102, and may coiled as illustrated in FIGS. 7 and 8. The light element 134 is also preferably rotatably mounted in the extendable arm member 102, so that it may directed in any number of directions. In fact, the light element in each of the embodiments are also preferably rotatably mounted in each of their respective extendable arm members. With the light elements being rotatably mounted, the light elements may also function as a work light if needed. The trailer guides (10,10′,40,60,100) may be mounted on any portion of the trailer, particularly if the trailer guide has magnetic removable attachment elements, and then the light element may be rotated to direct the light emitted therefrom to the needed area for working in the dark.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A trailer guide to assist a driver in visualizing the location of a trailer comprising:
an extendable arm member;
a mounting element for mounting the extendable arm member to a trailer, the extendable arm member being rotatably mounted to the mounting element to allow the extendable arm member to rotate relative to the mounting element;
a light element disposed at one end of the extendable arm member; and
a biasing element to bias the extendable arm member toward a first position relative to the mounting element.

2. The trailer guide according to claim 1, wherein the extendable arm comprises a first portion attached to the mounting element and a second portion slidingly connected to the first portion.

3. The trailer guide according to claim 2, wherein the second portion slides over the first portion.

4. The trailer guide according to claim 2, wherein the first portion and the second portion are securable to one another.

5. The trailer guide according to claim 1, wherein the light element is a reflector.

6. The trailer guide according to claim 1, wherein the light element is either a light bulb or an LED.

7. The trailer guide according to claim 1, wherein the biasing element is one of a magnet and an elastic member.

8. The trailer guide according to claim 7, wherein the elastic member is a spring.

9. The trailer guide according to claim 1, wherein the biasing element comprises at least two magnetic elements, and wherein one of the at least two magnetic elements is disposed on the extendable arm member and another of the at least two magnetic elements is disposed on the mounting element.

10. The trailer guide according to claim 1, wherein the mounting element comprises removable attachment elements to removably attach the trailer guide to a side portion of a trailer.

11. The trailer guide according to claim 1, to further comprising locking means to lock the extendable arm member relative to the mounting element.

12. The trailer guide according to claim 1, further comprising an actuator to move the extendable arm member between a first position and a second position.

13. A trailer guide comprising:
an arm member;
a mounting element for mounting the arm member to a trailer, the arm member being rotatably mounted to the mounting element to allow the arm member to rotate relative to the mounting element between a first position and a second position; and
a light element disposed at one end of the arm member such that the light element can be seen from a front portion of the trailer guide when the arm is rotated to the first position.

14. The trailer guide according to claim 13, wherein the arm member comprises a first portion attached to the mounting element and a second portion slidingly connected to the first portion.

15. The trailer guide according to claim 14, wherein the second portion slides over the first portion.

16. The trailer guide according to claim 14, wherein the first portion and the second portion are securable to one another.

17. The trailer guide according to claim 13, wherein the light element is a reflector.

18. The trailer guide according to claim 13, wherein the light element is either a light bulb or an LED.

19. The trailer guide according to claim 13, wherein the biasing element is one of a magnet and an elastic member.

20. The trailer guide according to claim 19, wherein the elastic member is a spring.

21. The trailer guide according to claim 13, wherein the biasing element comprises at least two magnetic elements, and wherein one of the at least two magnetic elements is disposed on the arm member and another of the at least two magnetic elements is disposed on the mounting element.

22. The trailer guide according to claim 13, wherein the mounting element comprises removable attachment elements to removably attach the trailer guide to a side portion of a trailer.

23. The trailer guide according to claim 13, further comprising locking means to lock the arm member relative to the mounting element.

24. The trailer guide according to claim 13, further comprising an actuator to move the arm member between a first position and a second position.
